(19) United States
(12) Patent Application Publication
(10) Pub. No.: US 2010/0181943 A1
(43) Pub. Date: Jul. 22, 2010

(54) Sensor-model synchronized action system

(76) Inventor: Charlie D. Phan, Memphis, TN (US)

Correspondence Address: CHARLIE D. PHAN, 1215 GARDEN RD., MEMPHIS, TN, 38134, US

(21) Appl. No.: 12/321,523

(22) Filed: Jan. 22, 2009

(51) Int. Cl. G05D 1/00

(52) U.S. Cl. 318/16

(57) ABSTRACT

The invention provides means to control model movement in a short distance or thousand miles away. Sensor source such as night sensor, pressure sensor, tilt sensor, sound sensor stimulates sensor activated unit to activate electric current flowing to electro motors and electromagnets to act on parts of model to control model activities and create live view and higher potential movements of action-model such as smiling, laughing, crying with tear, jumping, dancing, walking, talking or singing, eye glance or twinkling, eyelid opening or closing, ear raising or drooping and many physiological activities of living thing or mechanical movements of model.

### BACKGROUND OF THE INVENTION

1. Field of Invention

This invention relates to sensor-model synchronized action system, particularly, to the use of sensor, in a short distance or thousand miles away, to control activities of model to create live view and higher potential movements of action-model.

2. Description of Prior Art

Using night sensor to turn on light at night, using motion sensor to switch on security bulb, using touch sensor to cook rice, using sound sensor to clap-on a light, to activate light chase or to make flag moving and pressing button of wireless remote control to turn ON power are known in prior arts.

Known prior art includes:

U.S. Pat. No. 7,009,111; U.S. Pat. No. 6,845,001; U.S. Pat. No. 6,603,221; U.S. Pat. No. 6,313,513; U.S. Pat. No. 5,977,656; U.S. Pat. No. 5,227,750; U.S. Pat. No. RE38,069 U.S. Pat. No. 7,432,820; U.S. Pat. No. 7,183,929; U.S. Pat. No. 5,407,376; U.S. Pat. No. 4,843,497; U.S. Pat. No. 4,521,205; U.S. Pat. No. 4,207,696

U.S. Pat. No. 7,472,004; U.S. Pat. No. 7,472,000; U.S. Pat. No. 7,471,186; U.S. Pat. No. 7,296,467; U.S. Pat. No. 6,759,844

U.S. Pat. No. 7,471,967; U.S. Pat. No. 7,471,186; U.S. Pat. No. 6,380,844; U.S. Pat. No. D/583,816; U.S. Pat. No. D/583,777

Each of these prior design arts fulfills its respective in objectives and requirements but did not disclose a new device: the sensor-model synchronized action system, new theory and new method of action-model actions in the new invention.

To address these problems, the sensor-model synchronized action system provides the means to control and activate the action-model actions.

Thus, it is necessary to make a changing in theory and the operation way of model in order to create live view and higher potential movements of action-model.

### BRIEF SUMMARY OF THE INVENTION

The invention uses night sensor, pressure sensor, tilt sensor, sound sensor etc. to activate electromotor and electromagnet to act on parts of model to control model activities and create live view and higher potential movements of action-model. More particularly, the invention relates to sensor-model synchronized action system, an effective device to create action-model actions such as smiling, laughing, crying, jumping, dancing, talking or singing (live voice and song), eye glance or twinkling, eyelid opening or closing, ear raising or drooping, body balancing and many physiological activities of living thing and mechanical movements of models.

Sensor-model synchronized action system assembly as illustrated in FIGS. 1, 2, 3, 4, 5, 5A, 6, 6A, 7, 7A, 7B, 8, 8A, 9, 10 and 11 consists: model of human and animal puppet, model frame, sensor source, sensor activated unit, electric circuit, electromagnetic-switch, activated electric circuit, levering rod, string, spring, electromotor, electromagnet, model balance dish keeper, wireless remote controller magnetic switch, wireless remote controller, wireless remote receiver, speaker system, electric power sources, “pressure sensor-eye, eyebrow and ear synchronized action assembly”, “pressure sensor-eyelid synchronized action assembly”, “sound sensor-mouth synchronized action assembly”, “tilt sensor-model balance dish keeper synchronized action assembly”, “tilt sensor-upper limb synchronized action assembly”, “night sensor-lower limb synchronized action assembly” and “pressure sensor-wireless remote controller magnetic-switch synchronized action assembly”.

A sensor activated unit receives sensor source and activates one electric current (in lower power) to run small electromotor or small electromagnet and flowing to electromagnet-switch or wireless remote controller magnetic-switch to connect another electric current (in low or high power for huge model) to run electromotor or electromagnet. Electromotor has a handlebar that circles around electromotor axis. Electromotor handlebar circles and hits one end of levering rod to move levering rod around levering rod rotation axis. Moving levering rod helps to lever parts of model or to move them in 3D space. Active electromagnet pulls or pushes one end of levering rod to make the other end moving and parts of model acting.

When there is no sensor source there is not any electric current flowing, the electromotor and electromagnet do not active. When there is sensor source there is electric current flowing, the electromotor and electromagnet activate to control all activities of model. Accordingly, the sensor source, the sensor unit, the magnetic-switch, the electromotor or electromagnet, the levering rod, the frame part and the action-model begin each cycle of sensor-model synchronized action.

The devices of present invention use the conduct of several different sensors, unlimited, to control model frame interior to make a plurality of different motions of action-model and create action-model actions.

Optimally, this unit may be suitable for particular purposes of action-model using in parade, sport, ceremony, show, entertainment, karaoke, decorative place, education and may be suitable for industries of security, toy, show, physical move or lift, exercise, power chair, car, airplane, boat, space, home, garden and farm.

### BRIEF DESCRIPTION OF THE DRAWINGS

In the drawings, like elements are depicted by like reference numerals. The drawings are briefly described as follows:

FIG. 1 is a general diagrammatic perspective view of sensor-model synchronized action system SMS, illustration: sensor source SS, speaker system LS, sensor activated unit SU, magnetic-switch EMS, electric circuit SES, activated electric circuit AEC and model MO.

FIG. 2 is model frame diagrammatic perspective view of pressure sensor-eye, ear and eyebrow synchronized action, illustration: pressure sensor PSS, sensor activated unit SU, electric circuit SEC, speaker system LS, magnetic-switch EMS, activated electric circuit AEC, motor M, motor handlebar MHB, levering rod LR; eye, ear and eyebrow levering rods EEELR; eye, ear and eyebrow rods EEER and eye E, ear ER and eyebrow EB, spring SP and model frame MF.

FIG. 3 is a model frame diagrammatic perspective view of pressure sensor-eyelid synchronized action assembly in motionless position, illustration: Pressure sensor PSS, sensor activated unit SU, electric circuit SEC, electromagnetic-switch EMS, electromotor M, motor handlebar MHB, eyelid EL, eyelid levering rod ELR, pull string PS, eyelid spring ELS, model frame MF and right angle rod ERR, activated sensor unit SU to give an electric current (in low power) flowing through electromagnetic-switch EMS (or directly to electromotor M). Electromagnetic-switch EMS activates an activated electric circuit AEC (in low power or high power) flowing to electromotor M to circle electromotor handlebar MHB. Electromotor handlebar MHB pushes eyelid levering rod ELLR back, pulls the pull string PS and makes eyelid EL to close down (close-eyelid position). Spring ESP springs back eyelid levering rods ELR and back eyelid to previous open-eyelid position.

FIG. 4 is a model frame diagrammatic perspective view of sound sensor-mouth synchronized action assembly illustration: sound sensor SSS, sound activated unit SU, loud speaker system LS, electromagnetic-switch EMS, activated electric circuit AEC, mandible levering rod MDLR, rotation axis MA, tongue MT, mouth spring MSP and electromagnet MN.

FIG. 5 is a diagrammatic perspective view of upper-limb frame assembly in upright position, illustration: arm AP, arm levering rod ALR, elbow axis EJA, arm spring ASP, arm string AST, biceps electromotor BCM, vertical axis VA and shoulder joint horizontal axis SJHA.

FIG. 5A is a model frame diagrammatic perspective view of tilt sensor-upper limb synchronized action assembly in contracted position, view from model front, illustration: the moving of left arm levering rod LALR, shoulder joint horizontal axis SJHA, arm AP, right arm RA, left arm LA, vertical axis VA, model frame MF, shoulder motor SEM, shoulder string SST, front arm electromotor FAEM, rear arm electromotor RAEM front string FST, rear string RST; upper limb balance dish keeper ULBDK, model balance dish keeper MBDK, inverted electric circuit IEC, liquid pool LP, balance liquid H2O, model MO, model frame MF, liquid pump WP, left arm liquid pump LAWP, right arm liquid pump RAWP, siphon tube SIP and left arm pool LAP.

FIG. 6 is a diagrammatic section view of tilt sensor-model balance dish keeper synchronized action assembly in model MO upright position (inverted electric circuit is OFF), view from back, illustration: model balance dish keeper BDK, electric conductive liquid ECL, electric poles EP and inverted electric circuit IEC.

FIG. 6A is a diagrammatic section view of model balance dish keeper in an unbalance position (inverted electric circuit is ON), illustration: model balance dish keeper BDK, model MO, rotation axis, electric conductive liquid ECL, electric poles EP and inverted electric circuit IEC.

FIG. 7 is a model frame diagrammatic perspective view of night sensor-lower limb synchronized action assembly in upright position, view from back, illustration: night sensor NSS, pelvic rods PR, leg levering rod LLR, knee axis KJA, leg string LST, leg spring LSP, left thigh head LLH, right thigh head RLH, right thigh RT, right leg RL, right foot RF, left thigh LT, left leg LL, left foot LF, triceps motor TCM, left food night sensor unit LNSU, right foot night sensor unit RNSU, pull electromagnets EM1 and pull electromagnet EM2.

FIGS. 7A and 7B are model frame diagrammatic section views of night sensor-lower limb synchronized action assembly in upright position, view from right side, illustration: right thigh RT, left thigh LT, thigh axis RTA, left thigh axis LTA, right thigh head RTH, left thigh head LTH, pelvic rod PR, a vertical rotation axis VRA; pelvic rod PR, right leg RL, left leg LL, right leg RL, knee axis KJA, left night sensor unit LNSU, right night sensor unit RNSU, left foot LF, pull electromagnet EM2, right pelvic rod RPR, thigh RT, right leg RL, right foot RF, pull electromagnet EM1, left leg LL, left foot LF, right wheel electromotor RWEM and left wheel electromotor LWEM.

FIG. 8 is a diagrammatic section view of pressure sensor-wireless remote controller magnetic switch synchronized action assembly, illustration: ON/OFF wireless remote controller OFWCT, ON/OFF wireless remote receiver OFWRV, T shape levering rod TLR, wireless remote controller magnetic-switch electromagnet MSEMN, spring WSP, ON/OFF buttons, right wireless remote controller magnetic-switch electromagnet RMSEMN, left wireless remote controller magnetic-switch electromagnet LMSEMN and wireless remote controller magnetic switch base MSB.

FIG. 8A is an electric circuit diagram of pressure sensor-wireless remote controller magnetic-switch synchronized action assembly, illustration: sensor source SSS, sensor activated unit SU, sensor electric circuit SEC, ON/OFF wireless remote controller OFWCT, ON/OFF button, electric circuit ESC, ON/OFF wireless remote receiver OFWRV, wireless remote controller magnetic-switch WCMNS, activated electric circuit AEC, electromotor M, electromagnet MN, activated electric circuit AEC, sensor source SS2 and wireless remote controller magnetic-switch electromagnets MSEMN.

FIG. 9 is an electric circuit diagram of sensor-model synchronized action system, illustration: sensor source SS, sensor activated unit SU, sensor electric circuit SEC, small electromotor M1, small electromagnet MN1, electromagnetic-switch EMS, activated electric circuit AEC; electromotor M and electromagnet MN.

FIG. 10 is an electric circuit diagram of tilt sensor-model balance dish keeper, illustration: electric circuit SEC, electric conductive liquid ECL, liquid pump WP, electromotor M and electromagnet MN.

FIG. 11 is an electric circuit diagram of tilt sensor-upper limb balance dish keeper, illustration: electric circuit SEC, electric conductive liquid ECL, upper limb inverted electric circuit LLIEC, front arm electromotor FAEM and rear arm electromotor RAEM.

### REFERENCE NUMERALS USED IN THE DESCRIPTION

Sensor-model synchronized action system SMS

Model (human or animal puppet) MO

Model frame MF

Sensor source SS

Sensor activated unit SU
Electric circuit SEC

Electromagnetic-switch EMS
Activated electric circuit AEC

Levering rod LR
String ST
Spring SP

Pressure sensor-eye, eyebrow and ear synchronized action assembly SEEESA
Pressure sensor PSS
Eye, eye brow and ear levering rod EEELR
Eye, ear and eyebrow rods EEER
U shape rod axis UX
Eye E
Ear ER
Eye brown EB
Pull string PS

Pressure sensor-eyelid synchronized action assembly SELSA
Eyelid EL
Eyelid spring ELS
Eyelid right angle rod ERR

Sound-sensor mouth synchronized action assembly SMSA
Sound sensor SSS
Mouth M
Tongue MT
Mandible levering rod MDLR
Mouth spring MSP
Rotation axis MA

Electromotor M
Electromotor handle bar MHB
Small electromotor M1

Electromagnet MN
Small electromagnet MN1

Tilt sensor-balance model dish keeper synchronized action assembly BDKSA
Model balance dish keeper BDK
Electric conductive liquid ECL
Electric pole EP
Inverted electric circuit IEC

Tilt sensor-upper limb synchronized action assembly LULSA
Upper limb pool ULP
U shape rod USR
Left arm levering rod LALR
Elbow axis AJA
Elbow spring ESP
Arm string AST
Arm AP
Right arm RA
Left arm LA
Vertical axis VA
Shoulder joint horizontal axis SJHA
Front arm electromotor FAEM
Rear arm electromotor RAEM
Front string FST
Rear string RST
Arm electromotor AEM
Biceps electromotor BEM
Shoulder electromotor SEM
Shoulder string SST
Balance liquid H2O
Liquid pump WP
Left arm liquid pump LAWP
Right arm liquid pump RAWP
Siphon tube SIP
Left arm pool LAP
Right arm pool RAP
Upper limb balance dish keeper ULBDK
Left upper limb balance dish keeper LULBDK
Right upper limb balance dish keeper RULBDK
Upper limb inverted electric circuit LLIEC

Night sensor lower limb synchronized action assembly SLLSA
Pelvic rod PR
Pull electromagnet EM1
Pull electromagnet EM2
Left thigh head LTH
Right thigh head RTH
Left thigh LT
Right thigh RT
Left leg LL
Right leg RL
Right thigh axis RTA
Left thigh axis LTA
Knee axis KJA
Leg string LST
Leg spring LSP
Triceps electromotor TCM
Leg levering rod LLR
Right foot RF
Night sensor NSS
Right night sensor unit RNSU
Right wheel electromotor RWEM
Left foot LF
Left night sensor unit LNSU
Left wheel electromotor LWEM

Pressure sensor-wireless remote controller magnetic-switch synchronized action assembly WCTSA

Wireless remote controller magnetic-switch WCMNS
ON/OFF wireless remote controller OFWCT
ON button ON
OFF button OFF
ON/OFF wireless remote receiver OFWRV
Switch base MSB
T shape levering rod TLR
Magnetic-switch electromagnet MSEMN
T spring WSP
Right magnetic-switch electromagnet RMSEMN
Left magnetic-switch electromagnet LMSEMN
Wireless remote controller magnetic switch base MSB
Another pressure sensor SS2

Loud speaker system LS

Electric power sources VDC, VAC

### DETAILED DESCRIPTION OF THE INVENTION

Sensor-model synchronized action system assembly SMS as illustrated in FIGS. 1, 2, 3, 4, 5, 5A, 6, 6A, 7, 7A, 7B, 8, 8A, 9, 10 and 11, consists: sensor-model synchronized action system SMS (human or animal puppet model MO is used in this process), model MO, model frame MF, sensor source SS, sensor activated unit SU, electric circuit SEC, electromagnetic-switch EMS, activated electric circuit AEC, levering rod LR, string ST, spring SP; “pressure sensor-eye, eyebrow and ear synchronized action assembly SEEESA”: pressure sensor PSS, eye, eye brow and ear levering rod EEELR; eye, ear and eyebrow rods EEER, U shape rod USR, U shape rod axis, eye E, ear ER, eye brown EB, pull string PS, eye E; “pressure sensor-eyelid synchronized action assembly SELSA”: eyelid EL, eyelid spring ELS, eyelid right angle rod ERR; “sound sensor-mouth synchronized action assembly SMSA”: sound sensor SSS, mouth M, tongue MLR, mandible levering rod MDLR, mouth spring MSP, electromotor M, small electromotor M1, electromotor handle bar MHB and electromagnet MN, small electromagnet MN1; “tilt sensor-upper limb synchronized action assembly LULSA”: upper limb balance dish keeper ULBDK, upper limb pool ULP, arm levering rod ALR, elbow axis AJA, elbow spring ESP, arm string AST, arm AP, right arm RA, left arm LA, vertical axis VA, shoulder joint horizontal axis SJHA, front arm electromotor FAEM, rear arm electromotor RAEM, front string FST, rear string RST, arm electromotor AEM, biceps electromotor BEM, shoulder electromotor SEM, shoulder string SST, liquid pump WP, left arm water pump LAWP, right arm water pump RAWP, balance liquid H2O, siphon tube SIP, left arm pool LAP, right arm pool RAP; “tilt sensor-model balance dish keeper synchronized action assembly BDKSA”: model balance dish keeper BDK, electric conductive liquid ECL, electric poles EP and inverted electric circuit IEC; “night sensor-lower limb synchronized action assembly SLLSA”: pelvic rod PR, pull electromagnet EM1, pull electromagnet EM2, left thigh head LTH, right thigh head RTH, left thigh LT, right thigh RT, left leg LL, right leg RL, right thigh axis RTA, left thigh axis LTA, knee axis KJA, leg string LST, leg spring LSP, triceps electromotor TCM, leg levering rod LLR, right foot RF, right night sensor unit RNSU, right wheel electromotor RWEM, left foot LF, left night sensor unit LNSU, left wheel electromotor LWEM; “pressure sensor-wireless remote controller magnetic-switch synchronized action assembly WCTSA”: wireless remote controller magnetic-switch WCMNS, ON/OFF wireless remote controller OFWCT, ON button ON, OFF button OFF, ON/OFF wireless remote receiver OFWRV, switch base MSB, T shape levering rod TLR, magnetic-switch electromagnet MSEMN, T spring WSP, right magnetic-switch electromagnet RMSEMN, left magnetic-switch electromagnet LMSEMN, wireless remote controller magnetic switch base MSB, another pressure sensor SS2, loud speaker system LS and electric power sources VDC, VAC

Sensor source SS is agent stimulates sensor activated unit SU such as sun light, laser light, night, motion, tilt, pressure, liquid, sound etc.

Sensor activated unit SU receives sensor source SS and supply a low electric current.

Model MO is outer body to shape puppet, animal, man, car, boat etc. Model MO can be made of metal, rubber, plastic, linen, artificial skin etc. belong to type of model MO.

Frame Model frame MF is skeleton of body to support model.

Levering rod LR is made of metal, polyester or PVC plastic. Levering rod LR helps to move and to hold parts of model MO.

String ST pulls levering rod LR.

Spring SP keeps levering rod LR back to previous position.

Electromotor M and electromagnet MN pull/hold/push levering rod LR to make parts of model MO moving.

Electromagnetic-switch EMS connects activated electric circuit AEC operating in VDA/VAC regardless voltage power (U.S. Pat. No. 7,432,820)

Wireless remote controller magnetic-switch WCMNS connects or disconnect electric current by wireless remote controller OFWCT and wireless remote receiver OFWRV.

Model balance dish keeper BDK balances model MO, has electric poles EP around and electric conductive liquid ECL in center area. Depend on variety in type of model MO model balance dish keeper BDK can has 2 or 4, 8, 16, 32 etc. electric poles EP and different in dimensions. Inverted electric circuit IEC is circuit operating to opposite side electrical devices. Electric conductive liquid ECL can be sodium chloride, mercury, sulfuric acid or calcium chloride. Upper limb pool ULP contains balance liquid H2O and helps to balance model MO. Balance liquid H2O can be water, oil etc.

Loud speaker system LS is used for model MO speaking or singing in human voice.

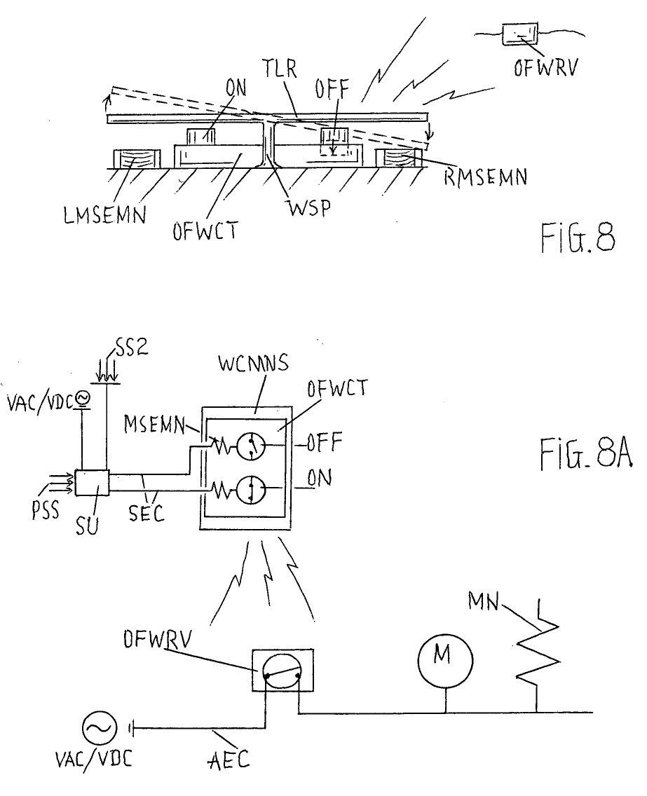

A sensor activated unit SU receives sensor source SS and activates one electric current (in lower power FIG. 9), to run directly small electromotor M1 and to act small electromagnet MN1 or indirectly through electromagnet-switch EMS to connect another electric current (in low power or high power for huge model) to run electromotor M and to act electromagnet MN, FIG. 9. Activated electric circuit AEC can be connected directly to electromotor M and electromagnet MN or indirectly to electromotor M and electromagnet MN through wireless remote receiver OFWRV or electromagnetic-switch EMS. We can use wireless remote controller magnetic-switch WCMNS, FIG. 8 to control wireless remote receiver OFWRV to turn ON/OFF activated electric circuit AEC or use a finger presses ON/OFF buttons on wireless remote controller OFWCT. Electromotor M has a handlebar MHB that circles around electromotor axis. Levering rod LR moves around its rotation axis by electromotor handlebar MHB hitting at one end of levering rod LR. Active electromagnet MN pulls or pushes one end of levering rod LR to make the other end moving. Moving of levering rod LR helps to lever parts of model MO up and down or to move them in 3D space.

When there is no sensor source SS there is not any electric current flowing, electromotor M and electromagnet MN do not active. When there is sensor source SS there is an electric current flowing, electromotor M and electromagnet MN activate to control activities of model MO. In the prior art the use of night sensor, motion sensor, touch sensor, pressure sensor, tilt sensor to trigger security light, to switch electric circuit, to make simple balance for equipment, to active moving and active speaker system. The normal appearance and operation of standard toy, model or equipment is effective only when there is sensor source SS trigger sensor unit SU to turn on electric circuit SEC to electromotor, to solenoid or to pre-recorded tape, an uninspired limited action; otherwise, toy or equipment does not continuously synchronized act, except in my previous invention “sound-flag synchronized action controller” U.S. Pat. No. 7,432,820 the flag continuously synchronized acts any time that has sound impulse. To address these problems, the sensor-model synchronized action system SMS provides the means to control activate and synchronized model movement The new invention uses night sensor, pressure sensor, tilt sensor, sound sensor to activate electromotor M and electromagnet MN to act on parts of model MO to control model activities and create live view and higher potential movements of action-model such as smiling, laughing, crying, jumping, dancing, talking or singing (live sound and music), eye glance or twinkling, eyelid opening or closing, ear raising or drooping, body balancing and many physiological activities of living thing and mechanical movements of models.

The synchronization between sensor source SS and movement of action-model MO is more exciting, useful and attractive when it is combined with other movement devices, dancing and comedy show, robot action, entertainment, karaoke, physical move or lifting, exercise, power chair, car, airplane, boat, space, home, garden and farm; specially model MO keeps balance in walking, sings a plurality songs along with human. Sensor-model synchronized action system assembly is predetermined in dimension, position, material, shape, electric power source and is maneuvered either by hand, by sensor, by wireless remote controller or by computer program. The sequence of sound-model synchronized action system is illustrated below:

FIG. 1 is a general diagrammatic perspective view of “sensor-model synchronized action system SMS”, consists: sensor source SS, sensor activated unit SU, speaker system LS, electromagnetic-switch EMS, electric circuit SES, activated electric circuit AEC and model MO.

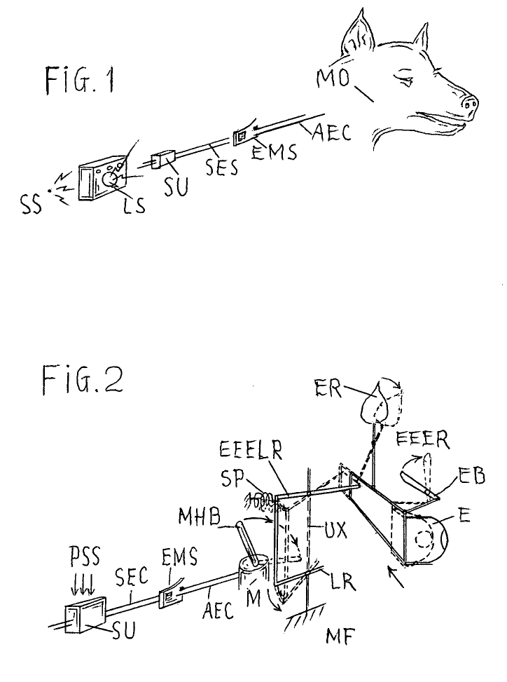

FIG. 2 is model frame diagrammatic perspective view of “pressure sensor-eye, ear and eyebrow synchronized action SEEESA”, consists: pressure sensor PSS, sensor activated unit SU, electric circuit SEC, speaker system LS, magnetic-switch EMS, activated electric circuit AEC, electromotor M, motor handlebar MHB, levering rod LR, eye, ear and eyebrow levering rod EEELR and eye E, ear ER and eyebrow EB. Eye, ear and eyebrow levering rod EEELR takes the shape of U having a spring SP at bottom of U and lies symmetrically on a rotation axis UX connects to model frame MF. Eye, ear and eyebrow levering rod EEELR connects to eye E, ear ER and eyebrow EB through eye, ear and eyebrow rod EEER by joints at two tops of U shape of eye, ear and eyebrow levering rod EEELR. Eye E, eyebrow EB and ear ER are maneuvered by electromotor M; motor handlebar MHB moves and pushes eye, ear and eyebrow levering rod EEELR and spring SP. Pressure sensor PSS activated sensor unit SU to give an electric current (in low power) flowing directly to electromotor M or indirectly through electromagnetic-switch EMS. Electromagnetic-switch EMS activates an activated electric circuit AEC (in low power or high power for huge model) flowing to electromotor M to circle electromotor handlebar MHB. Electromotor handlebar MHB circles and pushes the bottom of eye, ear and eyebrow levering rod EEELR at bottom to pull all eye, ear and eyebrow rods EEER to move and spring SP is stretching. At this point the two tops U shape of eye, ear and eyebrow levering rod EEELR moves backward and pulls back eye, ear and eyebrow rods EEER to make all eye E, ear ER and eyebrow EB acting. When there is no sound source SS there is not any electric current flowing, electromotor M do not act on eye, ear and eyebrow levering rod EEELR; therein spring SP springs back eye, ear and eyebrow levering rod EEELR and back all eye E, Ear ER and eyebrow EB to previous position. Accordingly, the pressure sensor PSS, the sensor activated unit SU, the electromagnetic-switch EMS, the electromotor M, eye, ear and eyebrow levering rod EEELR, eye, ear and eyebrow rods and the action-eye, ear and eyebrow EB begin each cycle in sensor-eye, eyebrow and ear synchronized actions.

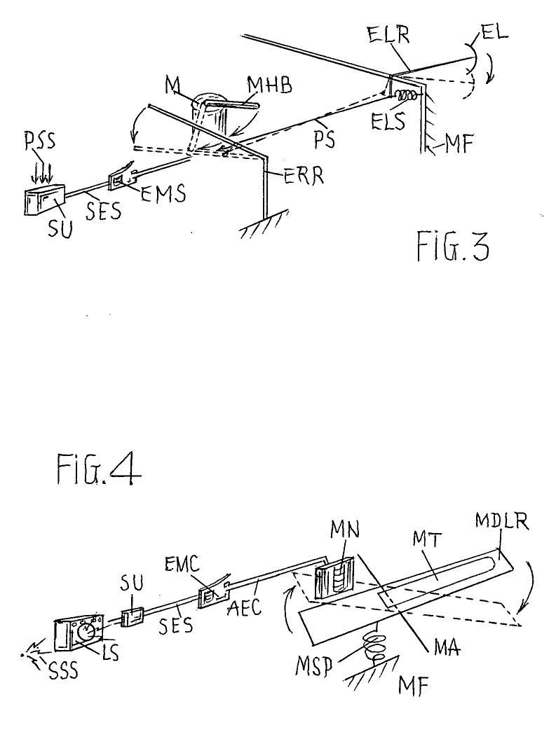

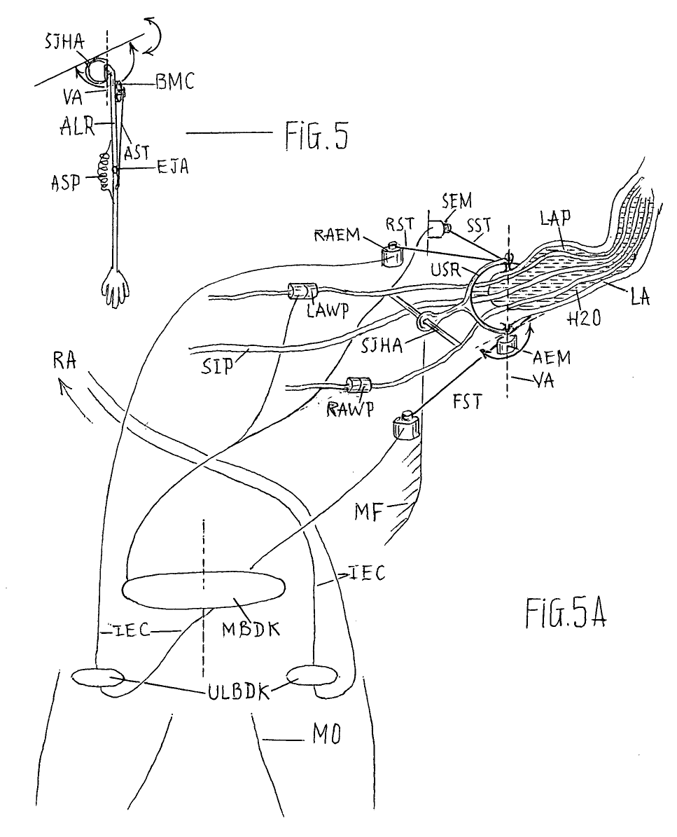

FIG. 3 is a model frame diagrammatic perspective view of “pressure sensor-eyelid synchronized action assembly SELSA”, consists: pressure sensor PSS, sensor activated unit SU, electric circuit SEC, electromagnetic-switch EMS, activated electric circuit AEC, electromotor M, electromotor handlebar MHB moves around motor axis; eyelid levering rod ELR uses to open and close eyelid EL, pull string PS and eyelid spring ELS. Eyelid levering rod ELR lies horizontal and rotates around an axis that stands on model frame MF. Eyelid EL has rotation axis at the angle of a right angle rod ERR. A pull string PS connects eyelid levering rod ELR with eyelid right angle rod ERR at one end. Pressure sensor PSS activated sensor unit SU to give an electric current (in low power) flowing directly to electromotor M or indirectly through electromagnetic-switch EMS. Electromagnetic switch EMS activates an activated electric circuit AEC (in low power or high power for huge model) flowing to electromotor M to circle electromotor handlebar MHB. Electromotor handlebar MHB circles and pushes eyelid levering rod ELLR back, pulls the pull string PS and makes eyelid EL to close down (close-eye position). When there is no electric current flowing, electromotor handlebar MHB does not move; therein eyelid spring ESP springs back eyelid levering rods ELR and back eyelid to previous open-eyelid position. Accordingly, the pressure sensor PSS, the sensor activated unit SU, the electromagnetic-switch EMS, the electromotor M, electromotor handlebar MHB, eyelid levering rod ELR, pull string PS, eyelid right angle rod ERR and eyelid EL begin each cycle in sensor-eyelid and eye brown synchronized action.

FIG. 4 is a model frame diagrammatic perspective view of “sound sensor-mouth synchronized action assembly” consists: sound sensor SSS, sound activated unit SU, loud speaker system LS, electromagnetic-switch EMS, activated electric circuit AEC, mandible levering rod MDLR, rotation axis MA, mouth spring MSP and electromagnet MN. Mandible levering rod MDLR is a rectangular shape and lies symmetrically on a rotation axis MA. The two ends of rotation axis MA hang on model frame MF at mouth width. Tongue MT is swingy stick on mandible levering rod MDLR. Electromagnet MN lies on interior side and at right angle with mandible levering rod MDLR.

Sound sensor-mouth synchronized action assembly SMSA is maneuvered by electromagnet MN. Mouth M of puppet model MO sings along with our voice or singer's voice (live sound and music) through speaker system LS. A sound activated unit SU receives sound sensor SSS and activates electromagnetic electric current (in low power FIG. 9) flowing directly to mouth electromagnet MN or indirectly through electromagnetic-switch EMS before it flows to mouth electromagnet MN. Electromagnetic-switch EMS connects activated electric circuit AEC (in low power or high power FIG. 9), an electric current flowing to mouth electromagnet MN to pull/hold one side of mandible levering rod MDLR up. At this point the other side of mandible levering rod MDLR goes down (opened mouth) and tongue swinging. When there is no sound sensor SSS there is not any electric current flowing, electromagnet MN do not act on mandible levering rod MDLR; therein mouth spring MSP pulls back mandible levering rod MDLR to previous closed mouth position. Accordingly, the sound sensor SSS, the sensor activated unit SU, the electromagnetic switch EMS, the electromagnet MN, the mouth spring MSP and the mandible levering rod MDLR begin each cycle in sound sensor-open/close mouth synchronized action.

FIG. 5 is a diagrammatic perspective view of upper-limb frame assembly in upright position, consists: arm levering rod ALR, elbow axis EJA, arm spring ASP, arm AP, arm string AST and shoulder joint horizontal axis SJHA, vertical axis VA and biceps electromotor BCM.

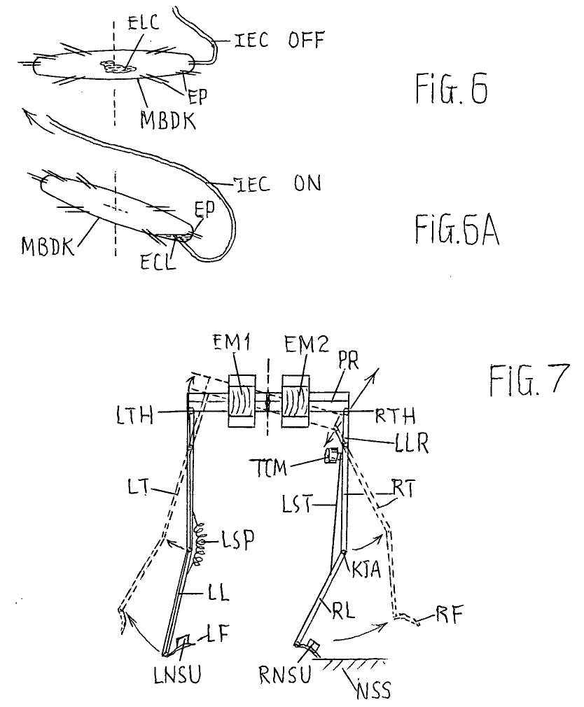

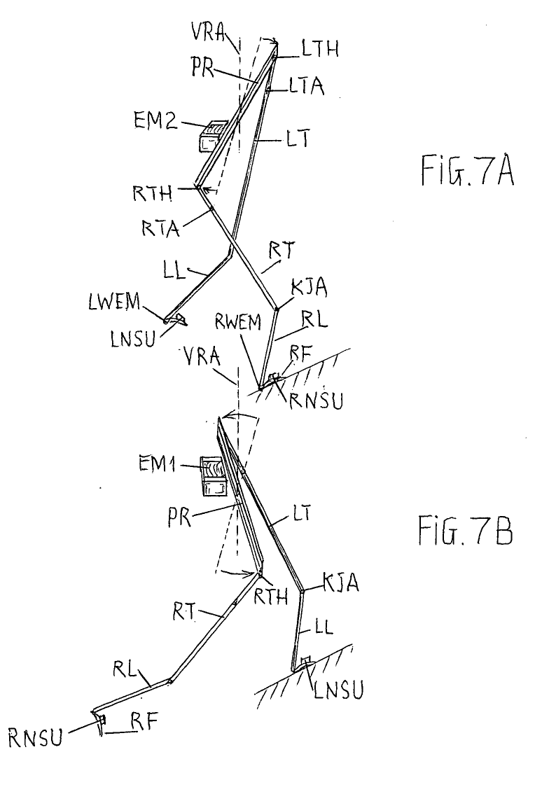

FIG. 5A is a model frame diagrammatic perspective view of “tilt sensor-upper limb synchronized action assembly LULSA”, view from model front, consists: arm AP, arm levering rod ALR has two straight rods joint at elbow axis EJA and an arm spring ASP connects and keeps two parts of arm levering rod ALR straight after contracting and swinging. An arm string AST connects two parts of arm levering rod ALR to move forearm and hand. Forearm and hand movements are pulled and released by biceps electromotor BCM connecting to arm string AST. Shoulder joint horizontal axis SJHA is complicated structure, consists: arm AP rotated around a vertical axis VA. Vertical axis VA of arm AP connects to a U shape rod USR rotating vertically by a shoulder joint horizontal axis SJHA on model frame MF. Vertical rotation up and down of U shape rod USR is controlled by shoulder electromotor SEM through shoulder string SST connects to U shape rod USR. Horizontal rotations forward and backward of arm AP are operated by front arm electromotor FAEM and rear arm electromotor RAEM through front string FST and rear string RST. Front arm electromotor FAEM and rear arm electromotor RAEM pull/release front string FST and rear string RST at sides of arm AP to make a horizontal moving of arm AP. Upper limb balance dish keeper ULBDK through upper limb inverted electric circuit LLIEC controls front arm string FST, rear arm electromotor RAEM and shoulder electromotor SEM. Upper limb balance dish keepers ULBDK is smaller than model balance dish keeper BDK, locate on a horizontal position in left lower limb thigh LT and right lower limb thigh RT, has same construction with the model balance dish keeper BDK but has only four electric poles EP. In lower limb walking action FIGS. 7A and 7B when right leg RL walk forward, right upper limb balance dish keeper RULBDK in right thigh RT tilts back down, electric conductive liquid ECL connects back electric pole EP to activate upper limb inverted electric circuit LLIEC to front arm electromotor FAEM to pull left arm LA moving forward. Left arm LA swings front far from model body (same direction with opposite right leg RL). At this moment left leg LL in the back, the left upper limb balance dish keeper LULBDK in left thigh LT tilts back up, electric conductive liquid ECL connects front electric pole to activate upper limb inverted electric circuit LLIEC to rear arm electromotor RAEM to pull left arm LA moving backward. Right arm RA swings back far from model body (same direction with opposite left leg LL). The same direction movements between left arm LA right leg RL, and right arm RA left leg LL keep the balance in walking movement of model MO. Rotations of arm vertical axis VA and shoulder joint horizontal axis SJHA create 3D movements for arm AP. Arm AP has a liquid pool LP inside, which contains liquid H2O such as water, oil etc. to keep balance for model MO. There is siphon tube SIP to level back liquid H2O in two arm pools and pumps WP to deliver weight of liquid H2O to and from arm AP under control of model balance dish keeper BDK to keep balance for model MO, FIG. 6A. Accordingly, tilt sensor-upper limb synchronized action assembly begins each cycle in tilt sensor-upper limb synchronized action.

FIG. 6 is a diagrammatic section view of “tilt sensor-model balance dish keeper synchronized action assembly BDKSA” in model MO upright position and view from back, consists: model balance dish keeper BDK, electric conductive liquid ECL, electric poles EP and Inverted electric circuit IEC. Model balance dish keeper BDK takes the shape of a dish that has dish cover to secure electric conductive liquid ECL inside and many electric poles EP around the dish BDK. Inverted electric circuit IEC is circuit operating to opposite side devices, left and right side of model MO. Electric conductive liquid ECL can be sodium chloride, mercury, sulfuric acid or calcium chloride and lies in center area of the dish BDK (inverted electric circuit IEC is in OFF position).

FIG. 6A is a diagrammatic section view of “tilt sensor-model balance dish keeper synchronized action assembly BDKSA” in unbalance position (inverted electric circuit IEC is ON), consists: model balance dish keeper BDK is located inside model MO on a horizontal surface, has the same vertical rotation axis as model MO. Model MO tilts down or up makes model balance dish keeper BDK tilts down or up the same angle. One typical action of model unbalance position is when model MO tilts down the right side, model balance dish keeper BDK tilts down the same right side. Electric conductive liquid ECL falls to the same right side to connect electric poles EP. An inverted electric circuit IEC is ON and electric current flowing to left arm water pump LAWP and shoulder electromotor SEM on opposite side. Left arm water pump LAWP pumps water into left arm pool LAP and shoulder electromotor SEM pulls left arm LA up. At this point the weight of left arm LA balances model MO to the upright position to keep balance for model MO. A siphon tube SIP siphons water from left arm pool LAP to right arm pool RAP to level water in upper limb pools ULP to secure model balance. When model balance dish keeper BDK returns to a horizontal position electric conductive liquid ECL slides back to the center area of model balance dish keeper BDK to cut OFF inverted electric circuit IEC.

As the same processing way as unbalance position of model MO, model body MO tilts down one side make model balance dish keeper BDK tilts down to that same side, the opposite side will be weighted down to keep balance for model MO. Accordingly, model MO, model balance dish keeper BDK, electric conductive liquid ECL, electric poles EP, inverted electric circuit IEC, arm water pump WP, shoulder electromotor SEM, upper limb pool ULP, shoulder electromotor SEM, siphon tube SIP begin each cycle in model balance synchronized action.

FIG. 7 is a model frame diagrammatic perspective view of “night sensor-lower limb synchronized action assembly SLLSA” in upright position and view from back, consists: night sensor NSS, pelvic rods PR, leg levering rod LLR, knee axis KJA, leg string LST, leg spring LSP, left thigh head LLH, right thigh head RLH, right thigh RT, right leg RL, upper limb balance dish keeper ULBDK, right foot RF, left thigh LT, left leg LL, left foot LF, triceps motor TCM, left food night sensor unit LNSU, right foot night sensor unit RNSU, pull electromagnets EM1 and pull electromagnet EM2.

FIGS. 7A and 7B are model frame diagrammatic section views of “night sensor-lower limb synchronized action assembly SLLSA” at upright position, in motion position and view from right side, consists: leg levering rod LLR has two straight rods joint at knee axis KJA. A leg spring LSP connects and keeps two parts of leg levering rod LLR straight after contracting and swinging. A leg string LST connects two parts of leg levering rod LLR to move leg L and foot F. Leg L and foot F movements controlled by triceps motor TCM connects to leg string LST. Right thigh RT and left thigh LT rotate forward and backward through right thigh axis RTA and left thigh axis LTA. Right thigh head RTH, left thigh head LTH joint with pelvic rod PR two ends. Pelvic rod PR is made of magnetic-metal has inverted moving around an axis and lies symmetrically through a vertical rotation axis VRA, FIG. 7. When the right part of pelvic rod PR moves backward the right thigh RT and right leg RL moves forward, FIG. 7A. At this moment the left part of pelvic rod PR moves forward makes the left thigh LT and left leg LL moves backward; in contrary, when the right part of pelvic rod PR moves forward right thigh RT and right leg RL moves backward and the left thigh LT and left leg LL moves forward, FIG. 7B. Movements of pelvic rod PR make lower limbs to walk. Pelvic rod PR is moved by pull electromagnets EM1 and pull electromagnet EM2 under the maneuver of night sensor NSS. Pelvic rods PR movements controlled by left night sensor unit LNSU and right night sensor unit RNSU lay under feet soles. Left foot LF stands at upright position letting left foot sole in the dark, left night sensor unit LNSU activates electric current that flows to pull electromagnet EM2 to pull the right pelvic rod RPR and the upper part of right thigh RT backward to move right thigh RT, right leg RL and right foot RF forward, FIG. 7A. The weight of whole right leg RL has a tendency to pull model MO forward and in a moment right foot RF touches floor letting right foot sole in dark, right night sensor unit RNSU activates left thigh electric current flowing to pull electromagnet EM1 to pull the left pelvic rod LPR and the upper part of left thigh LT backward to move the left thigh LT, left leg LL and left foot LF forward, FIG. 7B. The weight of whole left leg LL has a tendency to pull model MO forward and after that the left foot LF touches floor, a left night sensor unit LNSU continue activates in such above walk cycle. Accordingly, the dark, night sensor NSU, activated electric circuit EC, pelvic rods PR, leg levering rod LLR, knee axis KJA, leg string LST, leg spring LSP, left thigh head LLH, right thigh head RLH, right thigh RT, right leg RL, right foot RF, left thigh LT, left leg LL, left foot LF, triceps motor TCM, left food night sensors LNSU, pelvic rod PR, right foot night sensor RNSU, electromagnets EM1 and EM2 begin each cycle in night sensor-lower limb synchronized action.

It is amazing that upper limb balance dish keepers ULBDK locating down at lower limb because of the synchrorized relationship in body balancing keeping between upper limb and lower limb. There are two upper limb balance dish keepers ULBDK to keep model balance in walking, running movements of model MO. Upper limb balance dish keepers ULBDK are smaller than model balance dish keeper BDK, locate on a horizontal position in left lower limb thigh LT and right lower limb thigh RT and has same construction with model balance dish keeper BDK but has only four electric poles EP. In lower limb walking action FIGS. 7A and 7B when right leg RL walk forward, right upper limb balance dish keeper RULBDK in right thigh RT tilts back down, electric conductive liquid ECL connects back electric pole EP to activate upper limb inverted electric circuit LLIEC to front arm electromotor FAEM to pull left arm LA moving forward. Left arm LA swings front far from model body (same direction with opposite right leg RL). At this moment left leg LL in the back, the left upper limb balance dish keeper LULBDK in left thigh LT tilts back up, electric conductive liquid ECL connects front electric pole to activate upper limb inverted electric circuit LLIEC to rear arm electromotor RAEM and shoulder electromotor SEM to pull left arm LA moving up and backward. Right arm RA swings back far from model body (same direction with opposite left leg LL). The same direction movements between left arm LA-right leg RL, and right arm RA-left leg LL keep the balance in walking movement of model MO.

We can use a wireless remote controller OFWCT to turn OFF electric circuits to the night sensor units RNSU and LNSU to stand model MO at upright position and can let model MO walk around by turn ON one right wheel electromotor RWEM or one left wheel electromotor LWEM in model feet heels.

FIG. 8 is a diagrammatic section view of “pressure sensor-wireless remote controller magnetic switch synchronized action assembly WCTSA”, consists: wireless remote controller magnetic-switch WCMNS, ON/OFF wireless remote controller OFWCT, ON button ON, OFF button OFF, ON/OFF wireless remote receiver OFWRV switch base MSB, T shape levering rod TLR and wireless remote controller magnetic-switch electromagnet MSEMN. The horizontal part of T shape levering rod TLR made of magnetic metal and rotate around a horizontal axis in middle of T. The vertical part of T shape levering rod TLR is a spring metal WSP that lies in middle of ON and OFF buttons of ON/OFF wireless remote controller OFWCT. Right wireless remote controller magnetic-switch electromagnet RMSEMN and left wireless remote controller magnetic-switch electromagnet LMSEMN locate next two ends of T shape levering rod TLR. ON/OFF wireless remote controller OFWCT, T shape levering rod TLR, left wireless remote controller magnetic-switch electromagnet LMSEMN and right wireless remote controller magnetic-switch electromagnet RMSEMN lie on wireless remote controller magnetic switch base MSB. When sensor activated unit SU responds to pressure sensor PSS, electric current is created to flow to activate left wireless remote controller magnetic switch electromagnet LMSEMN. Left wireless remote controller magnetic-switch electromagnet LMSEMN pulls left part T shape levering rod TLR presses ON button down, ON/OFF wireless remote controller OFWCT is turned ON to order ON/OFF wireless remote receiver OFWRV turns ON to connect activated electric circuit AEC; after a while sensor activated unit SU responds to a different speed of pressure sensor PSS or another pressure sensor SS2, electric current is created to flow to activate right wireless remote controller magnetic-switch electromagnet electric RMSEMN. Right wireless remote controller magnetic-switch electromagnet RMSEMN pulls right part T shape levering rod TLR that presses OFF button down, ON/OFF wireless remote controller OFWCT is turned OFF to order ON/OFF wireless remote receiver OFWRV turns OFF electric circuit ESC. The sequence of turning ON and turning OFF of wireless remote controller magnetic-switch WCMNS is conducted by sensor source SS such as sun light, laser light, human, animal, motion, pressure, sound etc. to activate electric current flowing to electromotor M and electromagnet MN to act on parts of model MO to control model activities and create live view and higher potential movements of action-model such as smiling, laughing, crying, jumping, dancing, talking or singing, eye glance or twinkling, eyelid opening or closing, ear raising or drooping and many physiological activities of living thing or mechanical movements of model.

FIG. 8A is an electric circuit diagram of “pressure sensor-wireless remote controller magnetic switch synchronized action assembly WCTSA”, consists: pressure sensor PSS, sensor activated unit SU, sensor electric circuit SEC, ON/OFF wireless remote controller OFWCT, ON button ON, OFF button OFF, ON/OFF wireless remote receiver OFWRV, wireless remote controller magnetic-switch WCMNS, activated electric circuit AEC, electromotor M and electromagnet MN.

FIG. 9 is an general electric circuit diagram of “sensor-model synchronized action system SMS”, consists: sensor source SS, sensor activated unit SU, sensor electric circuit SEC, small electromotor M1, small electromagnet MN1, electromagnetic-switch EMS, activated electric circuit AEC; electromotor M and electromagnet MN.

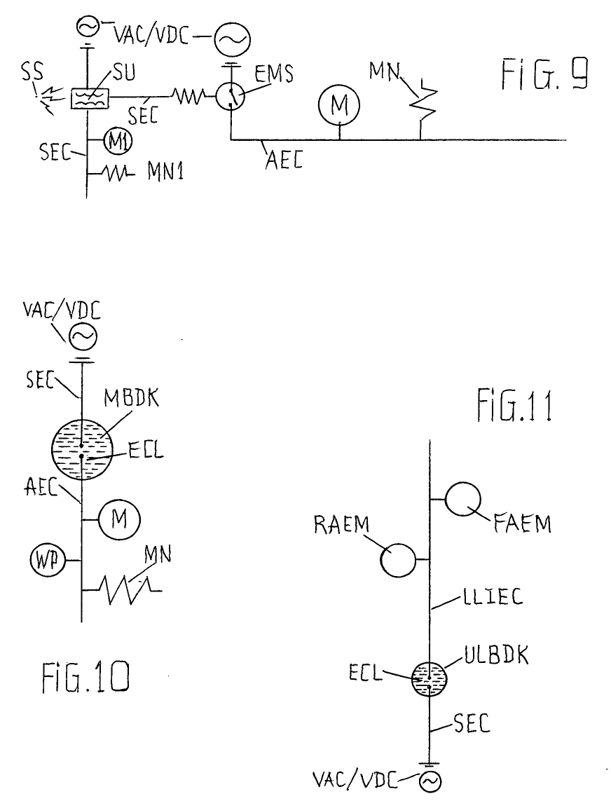

FIG. 10 is an electric circuit diagram of “tilt sensor-model balance dish keeper BDKSA”, consists: electric circuit SEC, electric conductive liquid ECL, liquid H2O, electromotor M and electromagnet MN.

FIG. 11 is an electric circuit diagram of “tilt sensor-upper limb balance dish keeper BDKSA”, consists: electric circuit SEC, electric conductive liquid ECL, upper limb inverted electric circuit LLIEC, front arm electromotor FAEM, rear arm electromotor RAEM.

It should be understood that the mercury electric conductive liquid ECL uses in needed industry only, not for toys.

Activated electric circuit AEC can be single-pole or poles and electric input circuits are fixed with AC domestic electric load or DC battery load. Activated electric circuit AEC can also be a heavy-duty industrial electric power load to operate several heavy motive devices such as motor, solenoid etc. in the movement not only of action-puppet, but also of machine and huge model.

In some case gear wheel can be used instead of string ST to pull/push/hold model frame MF.

All devices of sensor-model synchronized action system SMS are predetermined in sensor source, dimension, position, material, shape and electric power source VDC or VAC.

I claim:

1. Sensor model synchronized action system assembly consists: model, model frame, sensor source, sensor activated unit, electric circuit, electromagnetic switch, activated electric circuit, levering rod, string, spring, electromotor, electromagnet, small electromotor, small electromagnet, wireless remote controller magnetic switch, wireless remote controller, wireless remote receiver, pressure sensor eye, eyebrow and ear synchronized action assembly; pressure sensor eyelid synchronized action assembly; sound sensor mouth synchronized action assembly; tilt sensor model balance dish keeper synchronized action assembly; tilt sensor upper limb synchronized action assembly; night sensor lower limb synchronized action assembly; pressure sensor wireless remote controller magnetic switch synchronized action assembly; said sensor source is agent stimulates sensor activated unit such as sun light, laser light, night, tilt, liquid, motion, pressure and sound; said sensor activated unit receives sensor source and supply a low electric current; said model is outer body to shape puppet, animal, man, car and boat; said model is made of metal, rubber, plastic, linen, artificial skin belongs to model is an equipment, an animal, a human or a boat; said model frame is skeleton of body to support said model; said levering rod is made of metal, polyester or plastic; said levering rod helps to move and to hold parts of said model; said string uses pull levering rod; said spring keeps levering rod back to previous position; said electromotor and electromagnet pull, hold and push said levering rod to make parts of said model moving; said electromagnetic switch connects said activated electric circuit; said sensor activated unit receives said sensor source and activates one electric current to act directly on said small electromotor or said small electromagnet, in lower power, or indirectly through said electromagnetic switch to connect another electric current, in low power or high power for huge model, to run plurality of moving devices; said activated electric circuit is connected directly to said electromotor and said electromagnet or indirectly to said electromotor and said electromagnet through said wireless remote receiver and said electromagnetic switch; said wireless remote controller can be controlled by hand or by said wireless remote controller magnetic switch to act on said wireless remote receiver to turn ON, OFF said activated electric circuit; when there is no said sensor source there is not any electric current flowing, said electromotor and said electromagnet do not active; when there is sensor source there is an electric current flowing, said electromotor and said electromagnet activating to control activities of said model; accordingly, said sensor model synchronized action system assembly begins each cycle of sensor model synchronized action.

2. Pressure sensor eye, eyebrow and ear synchronized action of claim 1, wherein said sensor eye, eyebrow and ear synchronized action assembly consists: pressure sensor, sensor activated unit, electric circuit, magnetic switch, activated electric circuit, electromotor, motor handlebar, levering rod, eye, eye brow and ear levering rod; eye, ear and eyebrow rods, U shape rod, U shape rod axis, model frame, eye, ear, eye brown, pull string and eye; said eye, ear and eyebrow levering rods takes the shape of U that has said spring at bottom of U and lies symmetrically on said rotation axis connecting to said model frame; said eye, ear and eyebrow levering rods connects to said eye, ear and eyebrow through eye, ear and eyebrow rod by joints at two tops of U shape of said eye, ear and eyebrow levering rod; said electromotor handlebar moves and pushes said eye, ear and eyebrow levering rods and said spring; said eye, eyebrow and ear are maneuvered by electromotor; said a pressure sensor activate said sensor activated unit to give an electric current flowing to said electromagnetic switch; said electromagnetic switch activates said activated electric circuit, in low power or high power, flowing to said electromotor to circle said electromotor handlebar; said electromotor handlebar pushes the bottom of said eye, ear and eyebrow levering rods at bottom to pull all said eye, ear and eyebrow rods to move and said spring to stretch; at this point the two tops U shape of said eye, ear and eyebrow levering rods move backward and pull all said eye, ear and eyebrow rods to active on said eye, ear and eyebrow; when there is no said pressure sensor there is not any electric current flowing, said electromotor do not act on said eye, ear and eyebrow levering rods; therein said spring springs back said eye, ear and eyebrow levering rods and back said eye, said ear and said eyebrow to previous position; accordingly, said pressure sensor, eye, eyebrow and ear synchronized action begins each cycle of pressure sensor eye, ear and eyebrow synchronized action.

3. Pressure sensor eyelid synchronized action of claim 1, wherein said pressure sensor eyelid synchronized action assembly consists: pressure sensor, sensor activated unit, electric circuit, electromagnetic switch, activated electric circuit, electromotor, electromotor handlebar, eyelid levering rod, eyelid right angle rod, pull string, eyelid spring, eyelid and model frame; said electromotor handlebar moves around electromotor axis; said eyelid, said eyelid levering rod moves said eyelid, said pull string and said eyelid spring; said eyelid levering rod lies on a horizontal position and rotates around an axis, said axis standing on said model frame; said eyelid right angle rod has rotation axis at angle of said right angle rod; said pull string connects said eyelid levering rod with said eyelid right angle rod at one end; said pressure sensor stimulates said activated sensor unit to give an electric current, in low power, flowing directly to said electromotor or indirectly through said electromagnetic switch; said electromagnetic switch activates said activated electric circuit, in low power or high power, flowing to said electromotor to circle said electromotor handlebar, said electromotor handlebar pushes said eyelid levering rod back, said levering rod pulls said pull string and makes said eyelid to close down, closed eyelid position; when there is no electric current flowing, said electromotor handlebar does not move; therein said eyelid spring springs back said eyelid levering rods and back said eyelid to previous opened eye position; accordingly, said sensor eyelid synchronized action assembly begins each cycle of pressure sensor eyelid synchronized action.

4. Sound sensor mouth synchronized action of claim 1, wherein said sensor mouth synchronized action assembly consists: sound sensor, sound activated unit, loud speaker system, electromagnetic switch, activated electric circuit, mouth spring, tongue, mandible levering rod, rotation axis and electromagnet; said mandible levering rod is a rectangular shape and lies symmetrically on said rotation axis, two ends of rotation axis hang on said model frame at mouth width; said tongue sticks on said mandible levering rod at said rotation axis; said electromagnet lies on interior side and at right angle with said mandible levering rod; said mandible rod is maneuvered by said electromagnet; said speaker system lets puppet singing along with human voice or singer voice in live sound and music; said sound activated unit receives said sound sensor and supplies an electric current, in low power, flowing directly to said electromagnet or indirectly through said electromagnetic switch before flowing to said electromagnet; said electromagnetic switch connects said activated electric circuit, in low power or high power for huge model, to give an electric current flowing to said electromagnet to pull and hold or push one side of said mandible levering rod up; at this point the other side of said mandible levering rod goes down, said mouth opening and said tongue swinging; when there is no said sound source there is not any electric current flowing, said electromagnet does not act on mandible levering rod, therein said mouth spring pulls said mandible levering rod back to previous closed mouth position; accordingly, said sound sensor mouth synchronized action assembly begins each cycle in sensor open, close mouth synchronized action.

5. Tilt sensor model balance dish keeper synchronized action of claim 1, wherein said tilt sensor model balance dish keeper synchronized action assembly consists: model, model balance dish keeper, electric conductive liquid, electric pole and inverted electric circuit; said model balance dish keeper takes the shape of a dish, has dish cover to secure said electric conductive liquid inside and plural of electric poles around the dish; inverted electric circuit is circuit operating to opposite side devices such as said water pump, said electromotor and said electromagnet; said model balance dish keeper balances said model, has said electric poles around and said electric conductive liquid in center area; depend on variety in type of model said balance dish keeper can has 2 or 4, 8, 16, 32 said electric poles in different dimensions; said electric conductive liquid is sodium chloride, mercury, sulfiric acid or calcium chloride and lies in center area of said dish, at this point said inverted electric circuit is in OFF position; said model balance dish keeper is located inside said model on a horizontal surface, has the same vertical rotation axis as said model; when said model is in unbalance position said model tilts down or up makes said model balance dish keeper tilts down or up the same angle; such as said model tilts down to the right side, said model balance dish keeper tilts down to the same right side, said electric conductive liquid slides down to the right side to connect said electric poles; said inverted electric circuit is ON position and electric current flowing to operate electrical devices to bring more heavy weight to the opposite side, said opposite side is weighted down to make balance for said mode; when said model back to upright position said model balance dish keeper returns to a horizontal position and said electric conductive liquid slides back to the center area of said model balance dish keeper to cut said inverted electric circuit OFF, there are no said electrical devices operating, said model is kept balance; accordingly, said tilt sensor model balance dish keeper synchronized action assembly begins each cycle of tilt sensor model balance dish keeper synchronized action.

6. Tilt sensor upper limb synchronized action of claim 1, wherein said sensor upper limb synchronized action assembly consists: model balance dish keeper, upper limb balance dish keeper, upper limb levering rod, U shape rod, upper limb pool, siphon tube, arm levering rod, elbow axis, elbow spring, arm string, arm, arm, right arm, left arm, vertical axis, shoulder joint horizontal axis, front arm electromotor, rear arm electromotor, front string, rear string, arm electromotor, biceps electromotor, shoulder electromotor, shoulder string, liquid pump, left arm water pump, right arm water pump, balance liquid, siphon tube, left arm pool, right arm pool, model frame, electric poles, electric conductive liquid and upper limb inverted electric circuit; two straight rods of said arm levering rod joint at said elbow axis; said arm spring connects and keeps two parts of said arm levering rod straight after contracting and swinging; said arm string connects two parts of said arm levering rod to move forearm and hand; said forearm and hand movements controlled by said biceps electromotor connecting to said arm string; said shoulder joint horizontal axis is complicated structure, consists: said arm rotated around said vertical axis; said vertical axis of said arm connects to said U shape rod rotating vertically by said shoulder joint horizontal axis on said model frame; said vertical rotation of said U shape rod controlled by said shoulder electromotor through said shoulder string connecting to said U shape rod; horizontal rotations forward and backward of said arm are operated by said front arm electromotor and said rear arm electromotor through said front string and said rear string; said front arm electromotor and said rear arm electromotor pull and release said front string and said rear string at sides of said arm to make a horizontal moving of said arm; said upper limb balance dish keeper through said upper limb inverted electric circuit controls said front arm string, said rear arm electromotor and said shoulder electromotor; said upper limb balance dish keeper is smaller than said model balance dish keeper, locate on a horizontal position in said left lower limb thigh and said right lower limb thigh, has same construction with said model balance dish keeper but has only four said electric poles; in lower limb walking action when right leg walk forward, said upper limb balance dish keeper in right thigh tilts back down, said electric conductive liquid connects back electric pole to activate said upper limb inverted electric circuit flowing to said front arm electromotor to pull said left arm moving forward; said left arm swings forward far from model body, same direction with opposite right leg; at this moment left leg is in the back, said upper limb balance dish keeper in left thigh tilts front down, said electric conductive liquid connects front electric pole to activate said upper limb inverted electric circuit to said rear arm electromotor and said shoulder electromotor to pull said right arm moving up and backward; said right arm swings back far from model body, same direction with opposite said left leg; the opposite movements between said left arm, said right leg said right arm and said left leg keep a balance walking movement for said model; rotations of said vertical axis and said shoulder joint horizontal axis create 3D movements for said arm; said arm has said upper limb pool inside, containing said balance liquid such as water, oil, to keep balance for said model; under control of said model balance dish keeper said liquid pumps deliver weight of said balance liquid to and from said upper limb pool, and said siphon tube to level back said balance liquid into said upper limb pool to keep balance for model MO; accordingly, said tilt sensor upper limb synchronized action assembly begins each cycle in tilt sensor upper limb synchronized action.

7. Night sensor lower limb synchronized action of claim 1, wherein said lower limb synchronized action assembly consists: night sensor, left foot night sensor unit, right foot night sensor unit, pelvic rod, pull electromagnets, lower limb, leg levering rod, left thigh head, right thigh head, left thigh, right thigh, left leg, right leg, right thigh axis, left thigh axis, knee axis, leg string, leg spring, triceps electromotor, leg levering rod, right foot, left foot, leg, foot, right wheel electromotor, left wheel electromotor, left foot and left night sensor unit; said leg levering rod has two straight rods joint at said knee axis; said leg spring connects and keeps two parts of said leg levering rod straight after contracting and swinging; said leg string connects two parts of said leg levering rod to move said leg and foot; said leg and foot movements controlled by said triceps electromotor connecting to said leg string; said right thigh and said left thigh rotate forward and backward through said right thigh axis and said left thigh axis; said right thigh head, said left thigh head joint with said pelvic rod at two ends; said pelvic rod is made of magnetic metal, has an inverted movement and lies symmetrically through a vertical rotation axis; the right part of said pelvic rod moves backward making said right thigh and right leg moves forward; at this moment the left part of said pelvic rod moves forward making said left thigh and left leg moves backward; in contrary, when the right part of said pelvic rod moves forward said right thigh and right leg moves backward and said left thigh and left leg moves forward; movements of said pelvic rod make said lower limbs to walk; said pelvic rod is moved by said pull electromagnets under the maneuver of said night sensor; said pelvic rods movements controlled by said left night sensor unit and right night sensor unit under feet soles; said left foot stands at upright position letting left foot sole in the dark, said left night sensor unit activates electric current flowing to said pull electromagnet to pull said right pelvic rod and the upper part of said right thigh backward to move said right thigh, right leg and right foot forward; the weight of whole said right leg has a tendency to pull said model forward and said right foot touches floor letting right foot sole in the dark, said right night sensor unit will activate electric current flowing to said pull electromagnet to pull said left pelvic rod and the upper part of said left thigh backward to move said left thigh, left leg and left foot forward; the weight of whole said left leg has a tendency to pull said model forward and said left foot touches floor; said left night sensor unit continue activates in such previous walking cycle; to stand said model at upright position said wireless remote controller can turn OFF electric circuits to said night sensor units; said right wheel electromotor under said right foot heel or said left wheel electromotor under said left foot heel can let said model to turn around; accordingly, said night sensor lower limb synchronized action assembly begins each cycle in night sensor lower limb synchronized action.

8. Pressure sensor wireless remote controller magnetic switch synchronized action of claim 1, wherein said sensor wireless remote controller magnetic switch synchronized action assembly consists: pressure sensor, sensor activated unit, sensor electric circuit, wireless remote controller, ON button, OFF button, wireless remote receiver, wireless remote controller magnetic switch, activated electric circuit, electromotor and electromagnet; wireless remote controller magnetic switch, T shape levering rod, magnetic switch electromagnet, spring, right wireless remote magnetic switch electromagnet, left wireless remote magnetic switch electromagnet and wireless remote controller magnetic switch base; said wireless remote controller magnetic switch connects or disconnect electric current through said wireless remote controller and said wireless remote receiver; said horizontal part of T shape levering rod made of magnetic metal and rotate around a horizontal axis in middle of said T shape levering rod; said vertical part of said T shape levering rod is a spring that lies in middle of said ON and OFF buttons of wireless remote controller; said right wireless remote controller magnetic switch electromagnet and said left wireless remote controller magnetic switch electromagnet locate next two ends of said T shape levering rod; said wireless remote controller, said T shape levering rod, said left wireless remote controller magnetic switch electromagnet and said right wireless remote controller magnetic switch electromagnet lie on said wireless remote controller magnetic switch base; when said sensor activated unit responds to said pressure sensor to create electric current activating on said left wireless remote controller magnetic switch electromagnet; said left wireless remote controller magnetic switch electromagnet pulls left part of said T shape levering rod pressing ON button down, said wireless remote controller is turned ON to order said wireless remote receiver turning ON to connect said activated electric circuit; after a while said sensor activated unit responds to another pressure sensor or different speed pressure sensor to create electric current activating on said right wireless remote controller magnetic switch electromagnet; said right wireless remote controller magnetic switch electromagnet pulls right part of said T shape levering rod pressing OFF button down, said wireless remote controller is turned OFF to order wireless remote receiver turning OFF said activated electric circuit; the sequence of turning ON and OFF of said wireless remote controller magnetic switch is conducted by said pressure sensor or sensor sources such as sun light, laser light, human, animal, motion and sound to activate electric current flowing to said electromotor and said electromagnet to act on parts of said model to control physiological and mechanical movements of said model.

9. Said sensor model synchronized action controller system of claim 1 is predetermined in dimension, position, material, shape, electrical device, sensor source, electric power source and is maneuvered either by hand, by sensor, by wireless remote controller or by computer program.
